(19) United States
(12) Patent Application Publication
(10) Pub. No.: US 2010/0073436 A1
(43) Pub. Date: Mar. 25, 2010

(54) INK-JET HEAD

(75) Inventors: Young-Seuck YOO, Seoul (KR); Jae-Woo Joung, Suwon-si (KR); Pil-Joong Kang, Jinju-si (KR); Hee-Ju Son, Suwon-si (KR); Suk-Ho Song, Ansan-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/435,848

(22) Filed: May 5, 2009

(30) Foreign Application Priority Data
Sep. 19, 2008 (KR) 10-2008-0092038

(51) Int. Cl. B41J 2/175

(52) U.S. Cl. 347/85

(57) ABSTRACT

Disclosed is an inkjet head. The inkjet head in accordance with an embodiment of the present invention can include a body in which a plurality of chambers divided by partitions are formed; a plurality of actuators coupled to one side of the body respectively such that pressure is supplied to each of the plurality of the chambers; and a fixture coupled to one side of the body in correspondence to a position of each of the partitions such that vibrations of the partitions are reduced.

### CROSS-REFERENCE TO RELATED APPLICATIONS

This application claims the benefit of Korean Patent Application No. 10-2008-0092038, filed with the Korean Intellectual Property Office on Sep. 19, 2008, the disclosure of which is incorporated herein by reference in its entirety.

### BACKGROUND

1. Technical Field

The present invention relates to an inkjet head.

2. Description of the Related Art

An inkjet printer performs printing by converting an electrical signal into a physical force and ejecting ink droplets through a nozzle. Recently, there has been an increase in the density of nozzles formed in the inkjet printer, for the purpose of improving the print quality of the inkjet printer.

FIG. 1 is a front cross sectional view showing an inkjet head 10 according to a conventional technology. As shown in FIG. 1, with the increased density of nozzles 18 and 28, the density of chambers 16 and 26 being coupled to the nozzles 18 and 28 becomes higher, causing an interval and a partition 17 between the chambers 16 and 26 to be thinner.

Each of the nozzles 18 and 28 being formed in the inkjet head 10 should individually discharge ink. In this case, however, if any actuator 12 is operated to apply pressure to the chamber 16, the pressure is also applied to the adjacent chamber 26, generating interference between the chambers 16 and 26.

Such interference between the chambers aggravates the frequency characteristics of an inkjet head, and eventually deteriorates the print quality of the inkjet head.

### SUMMARY

The present invention provides an inkjet head that is capable of improving the print quality.

An aspect of the present invention features an inkjet head. The inkjet head in accordance with an embodiment of the present invention can include: a body in which a plurality of chambers divided by partitions are formed; a plurality of actuators coupled to one side of the body such that pressure is supplied to each of the plurality of the chambers; and a fixture coupled to one side of the body in correspondence to a position of each of the partitions such that vibrations of the partitions are reduced.

Here, the fixture can be separated from each of the plurality of the actuators adjacent to the fixture.

Meanwhile, the inkjet head can further include a coupling coupled to a plurality of fixtures and include a press member pressing the coupling toward the body. Here, the press member can include a frame covering one side of the body and supporting the other side of the body; and a press screw screw-coupled to one side of the frame such that the coupling is pressed.

### BRIEF DESCRIPTION OF THE DRAWINGS

FIG. 1 is a front cross-sectional view showing an inkjet head according to a conventional technology.

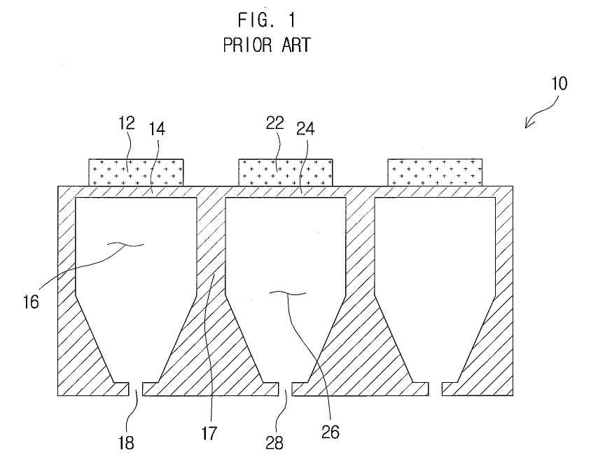

FIG. 2 is a front cross-sectional view showing an inkjet head according to a first embodiment of the present invention.

FIG. 3 is a cross-sectional side view showing an inkjet head according to a first embodiment of the present invention.

FIG. 4 is a front cross-sectional view showing an inkjet head according to a second embodiment of the present invention.

FIG. 5 is a front cross-sectional view showing an inkjet head according to a third embodiment of the present invention.

FIG. 6 is a front cross-sectional view showing another inkjet head according to a third embodiment of the present invention.

### DETAILED DESCRIPTION

Some of the characteristics and advantages of the present invention will be apparent through the following drawings and detailed description.

Hereinafter, embodiments of an inkjet head in accordance with the present invention will be described in detail with reference to the accompanying drawings. In description with reference to accompanying drawings, the same reference numerals will be assigned to the same or corresponding elements, and repetitive descriptions thereof will be omitted.

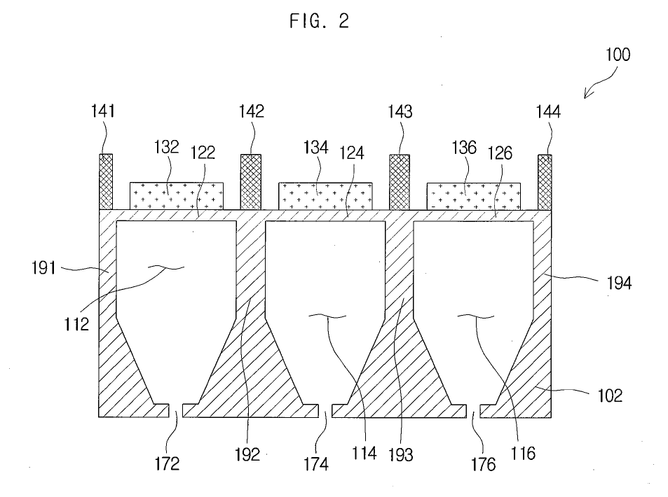

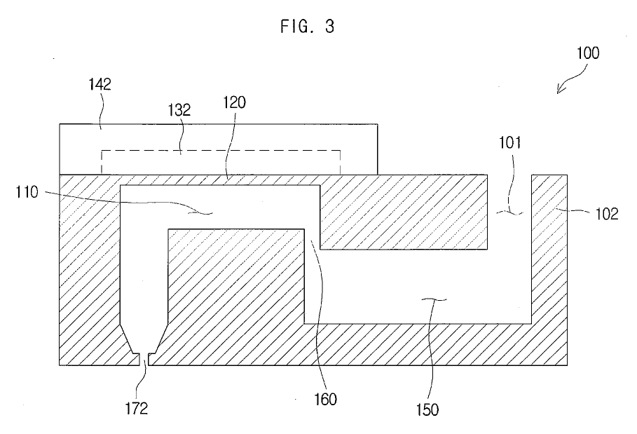

FIG. 2 is a front cross-sectional view showing an inkjet head 100 according to a first embodiment of the present invention. FIG. 3 is a cross-sectional side view showing an inkjet head 100 according to a first embodiment of the present invention. As shown in FIGS. 2 and 3, an inkjet head 100 according to a first embodiment of the present invention includes a body 102 in which a plurality of chambers 112, 114 and 116 divided by partitions 191, 192, 193 and 194 are formed, a plurality of actuators, each of which is coupled to one side of the body 102 such that each of the plurality of the chambers 112, 114 and 116 is supplied with pressure, and fixtures 141, 142, 143 and 144 coupled to one side of the body in correspondence to the position of each of the partitions 191, 192, 193 and 194 such that vibrations of the partitions are reduced. As a result, when driving the actuators, crosstalk is prevented from occurring among the adjacent chambers 112, 114 and 116, improving the print quality of the inkjet head 100.

The partitions 191, 192, 193 and 194 divide the inside of the body 102, forming a plurality of chambers 112, 114 and 116. The body 102 constitutes a trunk of the inkjet head 100, and can be formed by laminating a plurality of silicon wafers.

The partitions 191, 192, 193 and 194 are disposed inside the body 102 in a line, dividing the internal space of the body 102, and thus the plurality of the chambers 112, 114 and 116 can be formed in a line. The chambers 112, 114 and 116 can be connected to a reservoir 150 through a restrictor 160.

The reservoir 150 can accommodate the ink to be supplied to the chambers 112, 114 and 116. The reservoir 150 can be supplied with the ink from the outside through an inlet port 101.

The restrictor 160 is interposed between the reservoir 150 and the chambers 112, 114 and 116, thereby connecting the reservoir 150 and the chambers 112, 114 and 116. The restrictor 160 can perform the function of a channel supplying the ink to the chambers 112, 114 and 116.

The restrictor 160 can be formed to have a smaller cross-section than that of the reservoir 150. When the actuators supply pressure to the chambers 112, 114 and 116, the restrictor 160 can control the amount of ink supplied from the reservoir 150 to the chambers 112, 114 and 116.

The actuators can be coupled to one sides of the chambers 112, 114 and 116, respectively, such that the plurality of chambers 112, 114 and 116 are supplied with pressure, respectively. One side of the chambers 112, 114 and 116 can be covered with membranes 122, 124 and 126, respectively. The actuators can be individually coupled to one side of each of the chambers 112, 114 and 116, that is, one side of the body 102 in which the membranes 122, 124 and 126 are formed.

The actuator can generate vibration in accordance with the supplied voltage and provide the vibration to the chambers 112, 114 and 116 through the membranes 122, 124 and 126. An electrostatic method or a piezoelectric method and so on can be used for the actuator. For example, the actuator can be implemented by the piezoelectric method using piezoelectric materials 132, 134 and 136 in the embodiment of the present invention.

Nozzles 172, 174 and 176 can discharge the ink in the chambers 112, 114 and 116 to the outside. The nozzles 172, 174 and 176 can be formed on one side of the chambers 112, 114 and 116 facing the piezoelectric materials 132, 134 and 136. When the vibration generated by the piezoelectric materials 132, 134 and 136 is supplied to the chambers 112, 114 and 116, this pressure can discharge the ink in the chambers 112, 114 and 116 to the outside through the nozzles 172, 174 and 176.

In order to reduce the vibration of the partitions 191, 192, 193 and 194 contacting with the fixtures 141, 142, 143 and 144 caused by the vibrations of the chambers 112, 114 and 116 adjacent to the fixtures, the fixtures 141, 142, 143 and 144 can be coupled to one side of the body 102 in correspondence to the positions of the partitions 191, 192, 193 and 194, respectively. In other words, the fixtures 141, 142, 143 and 144 can be coupled to the positions at which the partitions 191, 192, 193 and 194 are formed on one side of the body 102.

The fixtures 141, 142, 143 and 144 are coupled to one side of the chambers 112, 114 and 116 having the piezoelectric materials 132, 134 and 136 coupled thereto, that is, one side of the body 102, and then can be coupled to the partitions 191, 192, 193 and 194. For example, the fixtures 141, 142, 143 and 144 can be coupled by laminating a silicon wafer on the body 102 just as the body 102 can be formed by laminating a plurality of silicon wafers.

The fixtures 141, 142, 143 and 144 can be a reinforcing member, which structurally fixes the partitions 191, 192, 193 and 194, reducing the vibrations of the partitions 191, 192, 193 and 194.

Because the fixtures 141, 142, 143 and 144 are coupled to the partitions 191, 192, 193 and 194, the partitions 191, 192, 193 and 194 can be supported by the fixtures 141, 142, 143 and 144. As a result, the partitions 191, 192, 193 and 194 can be structurally fixed by the fixtures 141, 142, 143 and 144 more stably.

Accordingly, the fixtures 141, 142, 143 and 144 can reduce the transfer of the vibration of the piezoelectric materials 132, 134 and 136, which are adjacent to the fixtures, to other adjacent chambers 112, 114 and 116 through the partitions 191, 192, 193 and 194. Additionally, the total mass of the partitions 191, 192, 193 and 194 is increased by as much as the mass of the fixtures 141, 142, 143 and 144. The partitions 191, 192, 193 and 194 can have an improved ability to absorb the vibration transferred by the adjacent chambers 112, 114 and 116.

As shown in FIG. 2, the fixtures 141, 142, 143 and 144 can be separated from each of the plurality of piezoelectric materials 132, 134 and 136 adjacent to the fixtures. Since the fixtures 141, 142, 143 and 144 are coupled to one side of the body 102 to which the piezoelectric materials 132, 134 and 136 are coupled, the fixtures 141, 142, 143 and 144 can be coupled to the one side of the body 102 without being in contact with the adjacent piezoelectric materials 132, 134 and 136. Therefore, it is possible to prevent the vibration generated by the piezoelectric materials 132, 134 and 136 from being transferred to the partitions 191, 192, 193 and 194 through the fixtures 141, 142, 143 and 144.

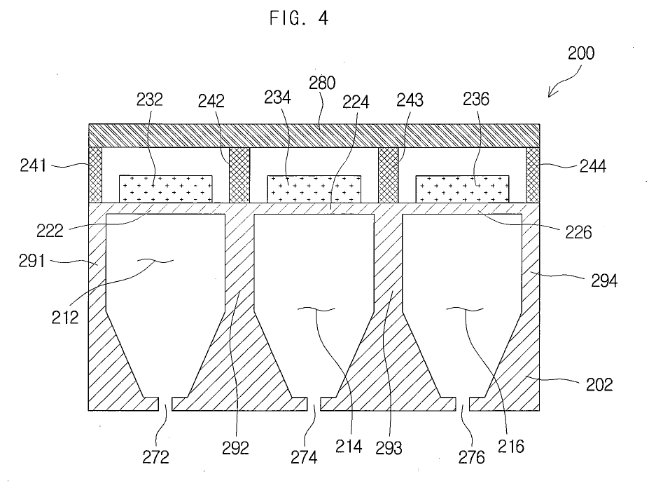

FIG. 4 is a front cross-sectional view showing an inkjet head 200 according to a second embodiment of the present invention. As shown in FIG. 4, the inkjet head 200 according to a second embodiment of the present invention can include a plurality of fixtures 214, 242, 243 and 244, and can further include a coupling 280 coupled to the plurality of fixtures 214, 242, 243 and 244.

The coupling 280 is coupled to the plurality of the fixtures 214, 242, 243 and 244, connecting and fixing the fixtures 214, 242, 243 and 244. In this case, each of the fixtures 214, 242, 243 and 244 structurally fixes partitions 291, 292, 293 and 294 more stably, reducing the transfer of the vibration of chambers 212, 214 and 216, which are adjacent to the fixtures, to other adjacent chambers 212, 214 and 216 through the partitions 291, 292, 293 and 294.

The partitions 291, 292, 293 and 294, for example, can be made of a silicon wafer and can be formed by laminating the silicon wafer on the fixtures 214, 242, 243 and 244.

The basal surface of the coupling 280 is separated from piezoelectric materials 232, 234 and 236, preventing the vibration generated by the piezoelectric materials 232, 234 and 236 from being transferred to the coupling 280 due to contact with the piezoelectric materials 232, 234 and 236.

Eventually, the pressure given to the adjacent chambers 212, 214 and 216 through the partitions 291, 292, 293 and 294 is not transferred to other adjacent chambers 212, 214 and 216, reducing the crosstalk among the adjacent chambers 212, 214 and 216 and improving the print quality of the inkjet head 200.

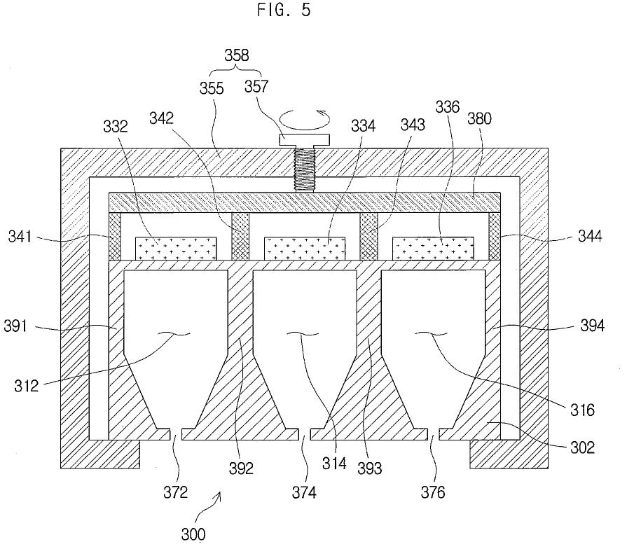

FIG. 5 is a front cross-sectional view showing an inkjet head 300 according to a third embodiment of the present invention. As shown in FIG. 5, the inkjet head 300 according to a third embodiment of the present invention can further include a press member 358 pressing a coupling 380 toward a body 302.

The press member 358 can further include a frame 355 and a press screw 357. The frame 355 can cover one side of the body 302 and support the other side of the body 302 as well. The frame 355 is formed to allow the press screw 357 to be screw-coupled by covering the one side of the body 302, to which the coupling 380 is coupled.

In addition, the other side of the frame 355 can support the other side of the body 302. Piezoelectric materials 332, 334 and 336 are coupled to the one side of the body 302. Nozzles 372, 374 and 376 can be formed on the other side of the body 302. Accordingly, the frame 355 can cover and support a part of the other side of the body 302 such that the nozzles 372, 374 and 376 are exposed.

The press screw 357 is screw-coupled to one side of the frame 355, pressing the coupling 380 toward the body 302. There can be a plurality of press screws 357. Positions to which the plurality of press screws 357 are coupled can be controlled according to behavior characteristics of the inkjet head 300.

The press member 358 presses the fixtures 314, 342, 343 and 344 to the side of the body 302, causing the fixtures 314, 342, 343 and 344 to support the partitions 391, 392, 393 and 394 more strongly. Therefore, it is possible to prevent the vibration more effectively from being transferred among chambers 312, 314 and 316 through the partitions 391, 392, 393 and 394.

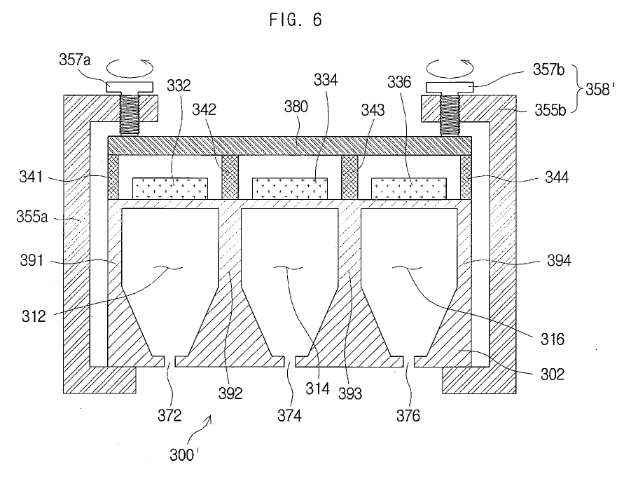

FIG. 6 is a front cross-sectional view showing another inkjet head 300′ according to a third embodiment of the present invention. As shown in FIG. 6, the inkjet head 300′ according to a third embodiment of the present invention can include a first frame 355a and a second frame 355b, which are separated from each other.

The first frame 355a and the second frame 355b are coupled to either side of the body 302 in order to press both sides of the coupling 380. The press screws 357a and 357b can be screw-coupled to one side of the first frame 355a and one side of the second frame 355b, respectively, in order to press the first frame 355a and the second frame 355b.

As such, the shape and arrangement relationship of a press member 358′ can be implemented in various shapes in accordance with a shape and behavior characteristics of the inkjet head 300′.

While the present invention has been described with reference to exemplary embodiments thereof, it will be understood by those skilled in the art that various changes and modification in forms and details may be made without departing from the spirit and scope of the present invention as defined by the appended claims.

What is claimed is:

1. An inkjet head comprising:
a body in which a plurality of chambers divided by partitions are formed;
a plurality of actuators coupled to one side of the body such that pressure is supplied to each of the plurality of the chambers; and
a fixture coupled to one side of the body in correspondence to a position of each of the partitions such that vibrations of the partitions are reduced.

2. The inkjet head of claim 1, wherein the fixture is separated from each of the plurality of the actuators adjacent to the fixture.

3. The inkjet head of claim 1, wherein there are a plurality of fixtures, and the inkjet head further comprises a coupling coupled to the plurality of fixtures.

4. The inkjet head of claim 3, further comprising a press member configured to press the coupling toward the body.

5. The inkjet head of claim 4, wherein the press member comprises:
a frame covering one side of the body and supporting the other side of the body; and
a press screw screw-coupled to one side of the frame such that the coupling is pressed.
